(19) United States
(12) Patent Application Publication
(10) Pub. No.: US 2013/0301999 A1
(43) Pub. Date: Nov. 14, 2013

(54) FIBER-OPTIC IMAGE GUIDE COMPRISING POLYHEDRON RODS

(71) Applicant: Hubertus Russert, Heidenrod (DE)

(72) Inventor: Hubertus Russert, Heidenrod (DE)

(73) Assignee: SCHOTT AG, Mainz (DE)

(21) Appl. No.: 13/989,997

(22) PCT Filed: Nov. 18, 2011
(86) PCT No.: PCT/EP2011/005814

§ 371 Date: Jul. 31, 2013

(30) Foreign Application Priority Data
Nov. 26, 2010 (DE) 10 2010 052 479.4

(51) Int. Cl. G02B 6/06; C03B 37/028

(52) U.S. Cl. CPC G02B 6/06; C03B 37/028
USPC 385/116; 65/409

(57) ABSTRACT

Fiber optic devices, methods for producing same, and uses of such optical devices are provided. The method includes combining light conducting rods to form bundles in accordance with predefined rules with respect to a cross-sectional area and number thereof in relation to a surrounding sheath, and are subjected to a drawing process. The strong fiber rod produced by the drawing process has an approximately hexagonal outer shape, and due to the drawing process the light conducting rods also have an approximately hexagonal outer contour. Thereby, a high packing density of about 99% is achieved in the fiber rod. Through a further process sequence of bundling and drawing these fiber rods, high-resolution multi-fiber rods are produced that include several thousand light conducting rods, the diameter of an individual light conducting rod included therein being less than 100 μm.

The invention relates to an optical device for transmitting electromagnetic waves, preferably in a range from 200 nm to 2 μm, to a method for producing same from fiber optic light conducting rods, and to the use of components produced by such method.

Fiber optic image guides which usually comprise a plurality of individual light conducting glass fibers referred to as light conducting rods below, have been known from their use in the field of optical image transfer in endoscopes for dental applications, for example. For transferring images, light conducting rods are joined to one another with an exactly parallel alignment over the entire length thereof.

An image supplied via the input face is divided by the individual light conducting rods and is transferred to the other end where the image is recomposed in a grid pattern. In fiber rods, the light conducting rods are fused together in parallel along their entire length. Each individual light conducting rod of the fiber rod corresponds to one image transfer point or pixel, the light conducting rods combined in the fiber rod substantially exhibiting the same optical properties as the individual light conducting rods.

For example, fiber optic image guides in medical technology comprise several thousand individual light conducting rods, the individual light conducting rods having a diameter from 2 to 20 μm.

High-resolution in the context of the invention refers to image guides in which the individual light conducting rods of the fiber rod have a diameter of less than 100 μm.

The manufacturing of such high-resolution fiber optic image guides has proved to be complex, since light conducting rods of equal length have to be placed in parallel alignment and have to be bundled. A non-optimal alignment means that, on the one hand, the bundle cannot be fully equipped with light conducting rods thereby leaving voids. On the other hand, permutations of image information may occur if the arrangement of the individual light conducting rods is not the same at the two ends of the fiber rod. As a result, the quality of image transfer will be deteriorated.

DE 102009004159A1 describes a possible method for producing parallel bundles and points out that the production of a bundle including a typical number of 1000 light conducting rods is very complex.

For this purpose, DE 102009004159A1 presents a procedure in which light conducting rods are placed in a sheathing tube and initially are arranged randomly which does not correspond to a state of optimal alignment. Optimal alignment refers to an arrangement in which all light conducting rods are disposed in parallel to one another.

By shaking the sheathing tube, the light conducting rods are placed in a state of higher organization, since the light conducting rods tend to assume lower energy states and thus to fill the gaps by self-organization. Voids occurring during this process of consolidation in the sheathing tube are then filled with additional light conducting rods.

By repeating the process steps of shaking and refilling for several times, the packing density can be increased. The packing density generally indicates the volume fraction of the sheathing tube which is filled with specific bodies, in this case light conducting rods.

As an alternative, DE 102009004159A1 discloses the very laborious option of manually arranging the individual light conducting rods in a mold or device. In this way, the light conducting rods can be arranged in an optimal manner, whereby a high packing density can be obtained.

An alternative is provided by DE 10059371A1 on the basis of a fiber optic image guide with light conducting rods which are not arranged in parallel. In order to nevertheless obtain an output image corresponding to the input image, an array camera with image sensors is used to determine an allocation of object points to image points using a calibration process. Assembly of the image—for instance on a monitor—is then accomplished based on the determined allocation pattern.

Generally, an optimum quality of image transfer will be achieved if all light conducting rods are arranged in parallel so that the best possible state of alignment is established. Moreover, the packing density should be as high as possible in order to achieve a fine grid of the image to be transferred. Finally, a high resolution is required for a high-quality image transmission, which resolution is determined by the size of the individual light conducting rods included in the fiber rod.

One drawback of the prior art methods for producing fiber optic image guides is to require an additional device, due to a non-parallel arrangement of the individual light conducting rods, in order to permit conversion of the input image in accordance with an allocation rule, so that it can be displayed at the output side.

Otherwise, all of the light conducting rods of the image guide have to be arranged in an aligned state, what has proved to be very complex, for example in case an optical device consists of several thousand light conducting rods and a high resolution is desired.

The shaking process described above enables to establish a comparatively high degree of alignment of the light conducting rods. However, it is not ensured that a state of highest possible organization of the light conducting rods can be achieved in any case.

Moreover, what is required in addition to a high degree of alignment of the light conducting rods is a high packing density. The latter is not ensured by the prior art method described. DE 102009004159A1 discloses an achievable packing density of about 90%.

The packing density furthermore depends in particular on the size of the light conducting rods included in relation to the sheathing system. For example, a few light conducting rods of large diameters can be aligned in parallel comparatively easily. However, it is not ensured that the sheathing system will be well filled by this bundle. In this case, although a state of good alignment may be achieved, the packing density will be too low.

The inventor has recognized these drawbacks and accepted the task to develop a simple method for producing a fiber optic device which permits to transfer electromagnetic radiation in a range from 200 nm to 2 μm.

In particular, this optical device should exhibit high optical resolution, with the light conducting rods having a diameter of less than 100 micrometers, and with a packing density of the fiber rods in a range of at least 90%, preferably more than 98%, more preferably at least 99%.

According to the invention, the light conducting rods are selected and produced in such a manner that based on their number and their outer diameter in relation to a surrounding sheath a very high packing density is or can be achieved.

To this end, the outer diameter D1 of the light conducting rods employed is selected according to the following rule:

D1=(D2−s)/(2·n+1)
with D1: outer diameter of an individual light conducting rod;
   D2: inner diameter of the sheathing tube;
   n: order; n=1, 2, 3, . . . ;
   s: oversize of the sheathing system (typically about 1 mm).

According to the present invention, the optimum number N of light conducting rods to be inserted into the sheath is determined based on the following rule:

N=1+3·((n+1)!/(n−1)!)

This method optimally promotes formation of a hexagonal outer shape of the light conducting rods in a subsequent process step. The packing density of the sheath in this case is about 60%.

For holding together the bundle, the light conducting rods may be introduced into an enclosing glass sheath, this sheath then also becoming part of the device by virtue of subsequent processes. The sheath may be provided in tubular shape, for example. It is also possible for the bundle to be held together by brackets or auxiliary devices which will not become part of the device later on.

The light conducting rods bundled in this manner are then supplied to a drawing process in a ring furnace wherein, by heat supply, the initially loose system is firmly fused into a mechanically homogeneous fiber rod.

Due to the bundling of the light conducting rods according to the invention, a fiber rod is produced by the drawing process which has a packing density in a range from 90% to more than 99%. This is achieved by a deformation of the outer contour of the light conducting rods, each of the light conducting rods assuming a substantially hexagonal outer shape. This deformation is more pronounced the closer the light conducting rods are arranged towards the center of the fiber rod. Due to this modification of outer contours, voids between the light conducting rods are reduced thereby increasing the packing density.

Moreover, it has been found that with such a configuration, the fiber rod itself will assume an approximately hexagonal outer contour, especially even if the sheath initially had a tubular cross-section.

The fiber rods produced according to the invention may be further combined according to the above described methodology into an aggregate bundle consisting of fiber rods of equal length. In this case, as a result of the approximately hexagonal outer contour of the fiber rods a very high packing density is already obtained in the sheath when forming an aggregate bundle from hexagonal fiber rods, which packing density will be in a range around 90%, preferably in a range above 98%, and more preferably in a range above 99%.

In this way, by passing through a further subsequent drawing process, multi-fiber rods may be produced which have a packing density of at least 99% or more.

In one specific embodiment, this subsequent drawing process is substantially used to produce a mechanically stable structure of fiber rods, the multi-fiber rod then being suitable for various subsequent treating processes. Subsequent treating processes for the multi-fiber rod include bending, drawing, upsetting, and also twisting, for example.

Thus, the method presently disclosed avoids both the drawback of having to manually arrange all of the light conducting rods of a fiber rod individually, as well as the drawback of a loss of transmission quality due to a low packing density.

Due to the high packing density of the aggregate bundle consisting of approximately hexagonal fiber rods, there are only a few remaining gaps in the bundle. Thereby, a further advantage results from the method of the invention.

If an aggregate bundle of fiber rods is subjected to a drawing process, a comparatively small draw ratio can be used, since the packing density is already very high and a further significant increase thereof by the drawing process is not imperatively required.

According to another specific embodiment, because of this small draw ratio or low degree of deformation required, other forming processes such as compressing or collapsing in vacuum may be employed instead of the drawing process.

Advantageously, an optical device is provided, in particular a high-resolution fiber optic image guide, for transmitting electromagnetic radiation in a wavelength range from 200 nm to 2 μm, which comprises light conducting rods having approximately hexagonal outer contours which have been produced from bundled light conducting rods by one or more drawing operations and which exhibit a packing density of at least 90%, preferably more than 95%, and more preferably at least 98%, and a resolution of less than one millimeter, preferably less than 100 μm.

Optical resolution in the sense of the invention refers to the diameter of one individual light conducting rod of the optical device, which determines the fineness of the grid of the image to be transmitted. High-resolution according to the present invention refers to fiber optic image guides in which the individual light conducting rod of the fiber optic image guide has a diameter of less than 100 μm.

In this way, a device for image transmission is provided which allows for a very fine grid of the image to be transferred and so is suitable for an image transmission with very high demands on detailing.

Particularly advantageously, an optical device is provided in which the bundles of light conducting rods comprise N individual light conducting rods, with

N=1+3·((n+1)!/(n−1)!)
wherein n: order; n=2, 3, . . . ;
   and wherein a fiber rod is formed by the drawing process, since a very high packing density of the fiber rod can be achieved in this manner, which is in particular at least 90%, preferably at least 95%, and more preferably at least 98%.

The bundled light conducting rods are enclosed by a tubular sheath, so that they are easily held and can be optimally subjected to an elevated temperature, in particular in a subsequent drawing process which is preferably performed in a ring furnace.

In one specific embodiment, the fiber rods produced according to the invention are further bundled, the bundle comprising N individual fiber rods, with

N=1+3·((n+1)!/(n−1)!)
wherein n: order; n=2, 3, . . . .

An advantage resulting therefrom is that the resolution of the optical device is further increased while at least maintaining the already very high packing density.

The fiber rod of the optical device produced according to the invention has an approximately hexagonal outer contour, since the included light conducting rods preferably assume a hexagonal cross-sectional shape, so that a greatest possible packing density can be achieved.

For producing the optical device according to the invention, parallel light conducting rods of equal length are bundled, the cross-sectional area and the number of the light conducting rods being selected in relation to the cross-sectional area of a surrounding sheath, the bundled light conducting rods are held together by a sheath or by an auxiliary device, and the bundled light conducting rods are subjected to a drawing process during which the light conducting rods are fused to one another by heat supply. In this way, a mechanically strong fiber rod is produced, which consists of a multitude of individual light conducting rods.

In another embodiment, the bundle of parallel light conducting rods may be exposed to heat and pressure, for example in order to promote a specific shaping.

In one particular embodiment, this process of subjecting the bundle to heat and/or pressure is performed under vacuum or in an inert gas atmosphere, in order to meet specific requirements, for example on purity.

Advantageously, the outer diameter D1 of a light conducting rod is selected according to the following rule:

D1=(D2−s)/(2−n+1)
with D1: outer diameter of the light conducting rod;
   D2: inner diameter of the sheathing tube;
   s: oversize of the sheathing system.

In this way, the optimal packing density of the bundle for forming a hexagonal outer shape of the light conducting rods in a subsequent process step is achieved, the packing density being about 60%.

In a subsequent process, the fiber rod is advantageously divided into rod segments or into disk-shaped rod portions to be used as a fiber optic image guide.

In another advantageous embodiment according to the invention, the rod segments of the fiber rod are supplied to a further bundling and drawing process. In this way, a multi-fiber rod may be produced, wherein the diameter of a light conducting rod in such a multi-fiber rod does not exceed 100 μm, so that the multi-fiber rod constitutes a high-resolution fiber optic image guide in the sense of the invention.

The so produced multi-fiber rod has a packing density of at least 90%, preferably at least 98%, and most preferably at least 99%.

The optical device according to the invention can be used, for example, as a light-transmissive cover for protecting weather-sensitive surfaces, for example for protecting optical instruments, clocks, or sensors such as CMOS sensors or CCD sensors.

Furthermore, the high-resolution optical image guide according to the invention may also be used to transfer pictures from a point of origin, which is in an exposed location in terms of high temperatures, for example, or in a potentially explosive environment, to another place where such exposure does not exist or is reduced.

This may for example include chemical reaction vessels which comprise an optical device in the sense of the invention.

In particular, common optical devices such as periscopes or endoscopes may also be equipped with an optical device in the sense of the invention.

Application examples of the invention will now be explained in more detail with reference to the following figures.

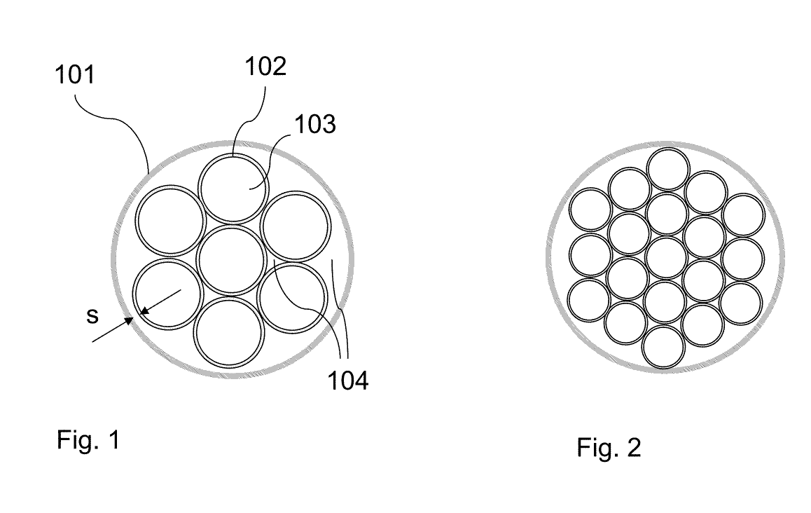

FIG. 1 is a cross-sectional view of a tubular sheath filled with 7 light conducting rods. Here, 101 designates the surrounding sheath. 104 designates the voids between the light conducting rods. The illustrated light conducting rod comprises a cladding glass (102) and a core glass (103). The oversize between the enclosing sheath and the light conducting rods is indicated by s.

FIG. 2 is a cross-sectional view of a sheath including 19 light conducting rods.

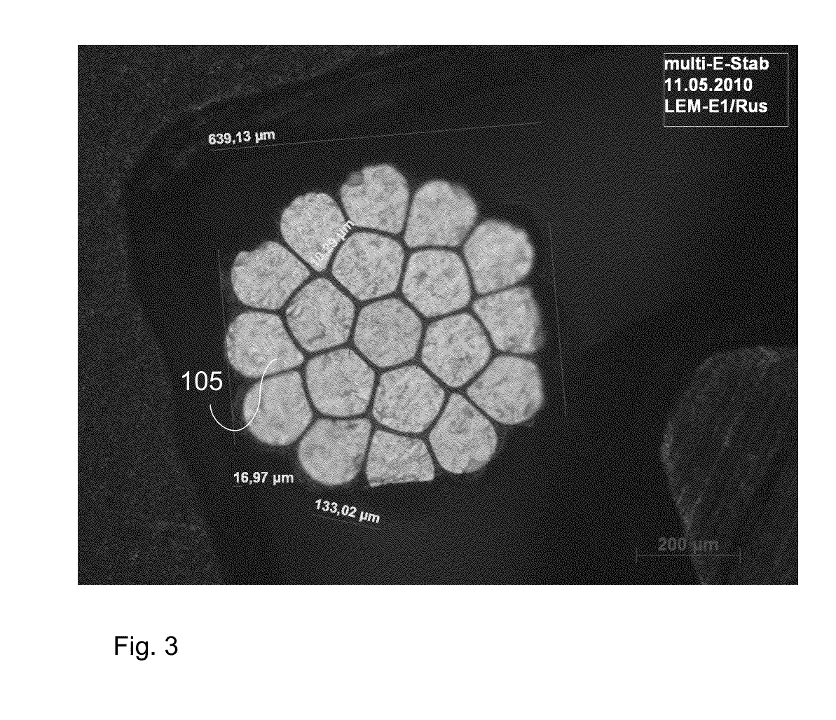

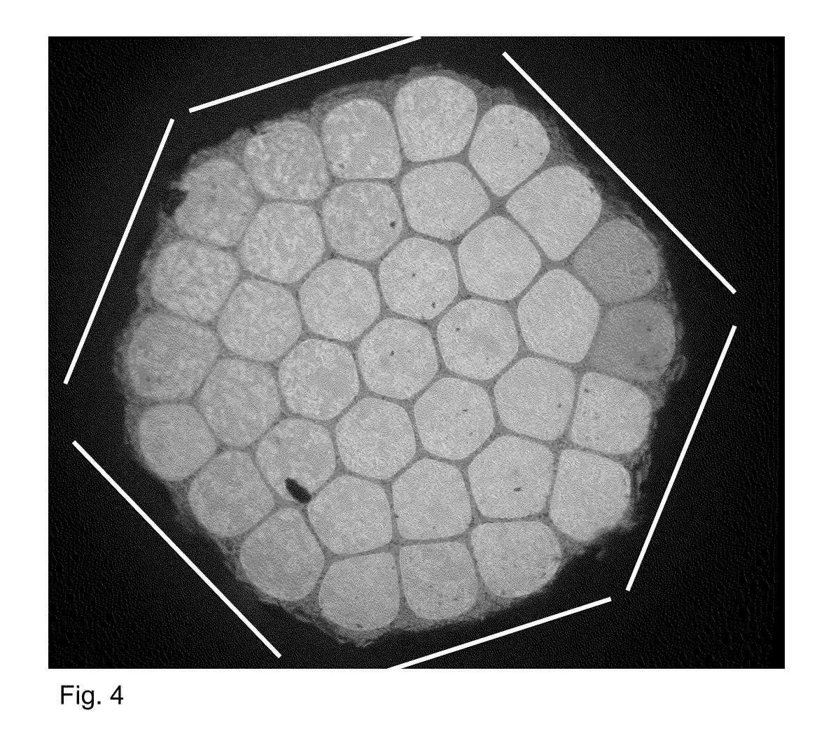

FIG. 3 is a cross-sectional view of a fiber rod which has been drawn and which includes 19 individual light conducting rods. Here, 105 designates an individual light conducting rod. The width across flats of the illustrated fiber rod is approximately 640 μm, and the width across flats of an individual light conducting rod within the fiber rod is approximately 133 μm.

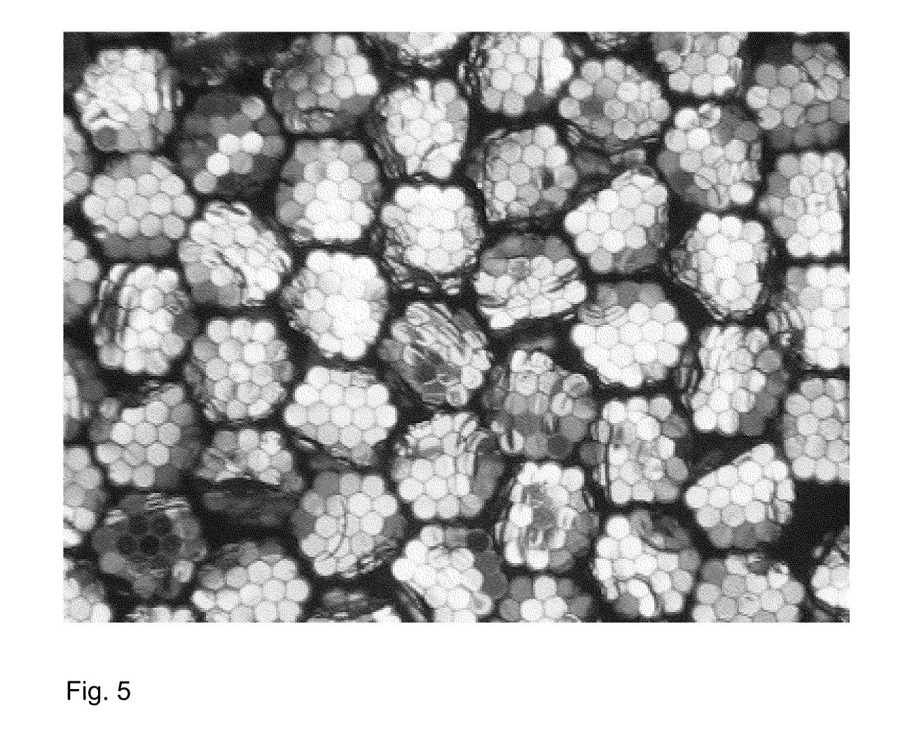

FIG. 4 illustrates a cross-sectional view of a fiber rod which has been drawn and which includes 37 individual light conducting rods. The white lines shown are intended to underline the basic hexagonal structure of the fiber rod.

A section of a cross-sectional view of a multi-fiber rod produced according to the invention is shown in FIG. 5

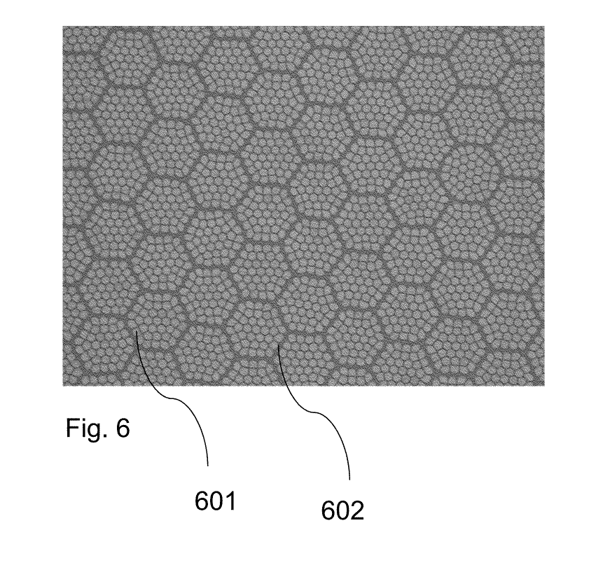

FIG. 6 is a cross-sectional view of a multi-fiber rod with an ideal alignment. Here, 601 designates an individual light conducting rod of a fiber rod, and 602 designates the sheathing system of a fiber rod. In FIG. 6, a multitude of fiber rods can be seen having approximately hexagonal cross sections.

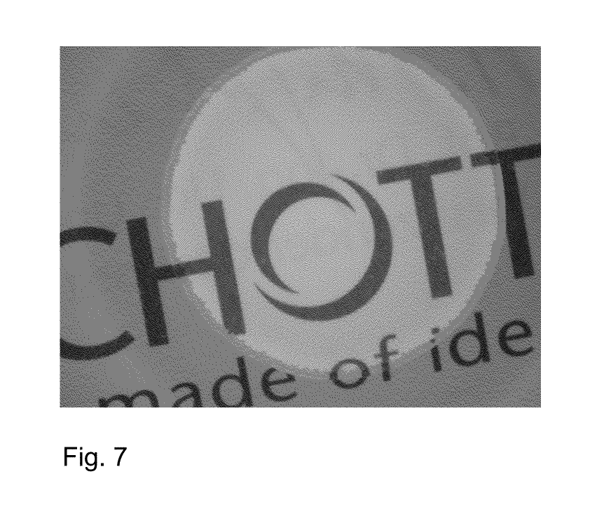

FIG. 7 illustrates image transmission using an image guide produced in this manner, with a diameter of the multi-fiber rod of 20 mm.

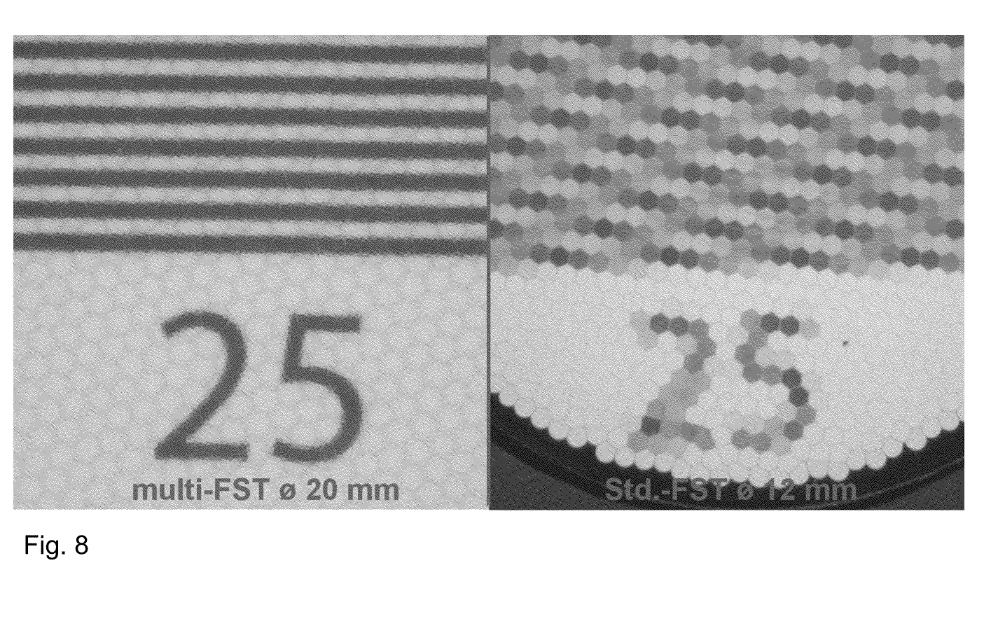

FIG. 8 shows a comparison of transfer qualities.

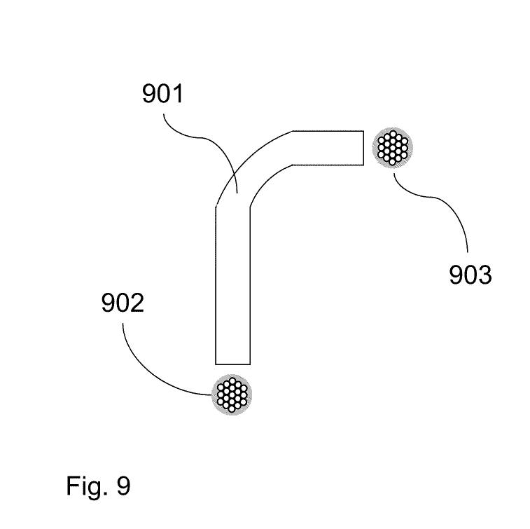

FIG. 9 shows an optical device according to the invention, which can be used for periscopes, for example. Here, the fiber rod 901 has been bent by an additional heat treating process. The arrangement of the light conducting rods of the fiber rod is identical at both ends thereof (902, 903). The quality of image transfer will not be affected by the bending of the fiber rod.

### EXEMPLARY EMBODIMENT

One exemplary embodiment of the invention for producing a fiber optic image guide will be illustrated below, only one possible variation thereof being described herein.

Light conducting rods are to be understood as rod/tube systems from glass which are able to transfer electromagnetic waves in a range from 200 nm to 2 μm and thus permit to transfer light. Light conducting rods generally comprise a core glass (103) which constitutes the rod, and a cladding glass (102) having the function of a tube. The core glass has a refractive index greater than that of the surrounding cladding glass. This construction enables transmission of light through reflection at the boundary surfaces of the inner and outer glass.

A light conducting rod usually has a round cross-section and is typically drawn from a rod/tube system which in its original state has an outer diameter in a range from about 30 to 40 mm. According to the invention, a cladding glass having a comparatively large wall thickness in a range of more than 1 mm is selected for the tube.

The light conducting rod is usually produced from the rod/tube system by a drawing operation. Typically, a light conducting rod so produced has an outer diameter in a range from 0.1 to 10 mm. Following the drawing process, the as-drawn light conducting rod is divided into rod-shaped sections.

The drawing process is characterized by the draw ratio which reflects the ratio of the drawing rate Va in relation to the feeding rate Vn. In this case, the drawing rate is greater than the feeding rate.

The light conducting rods thus produced are combined to form bundles of parallel light conducting rods of equal length, wherein a single bundle may comprise several or even many hundreds of individual light conducting rods. According to the present invention, bundles of light conducting rods consisting of 7, 19, 37, 61, 91, etc., individual light conducting rods are particularly advantageous. The sheath surrounding the bundle may also be a tube-shaped cladding glass, wherein in this case a cladding glass of a small wall thickness of for example about 1 mm or less is preferred according to the invention.

Such a bundle of light conducting rods typically has an outer diameter in a range from 30 to 40 mm and is supplied to another drawing operation to produce a fiber rod. By virtue of the drawing operation, the packing density of the supplied bundle increases, and the cross-section is reduced. The fiber rod so produced may for example have an outer diameter, or a width across flats, in a range of up to 1 mm. Usually, the fiber rod is divided into rod-shaped or disc-shaped portions.

In order to obtain larger diameters of the fiber rod, for example of about 20 mm or more, and/or to enhance the resolution of the fiber rod, it is possible to further bundle a plurality of fiber rods of equal length in parallel using the above methodology and to subject them to a further drawing process.

Instead of a drawing process, a pressing operation or a combination of drawing and pressing may be used at this point, wherein the fiber rods are fused together by supply of heat or heat and pressure. This process sequence may be repeated several times.

For example, according to this method, in order to produce a high-resolution fiber optic image guide with approximately 148,000 fiber optic rods according to the present invention, 37 light conducting rods of equal length and of an outer diameter of about 5 mm may first be arranged in parallel and bundled in a sheath having an outer diameter of about 35 mm.

When having been subjected to a drawing process, a fiber rod is produced which has a width across flats of about 0.6 mm and a packing density of about 99%.

Then, in a further process step, about 4,000 of so produced nearly hexagonal fiber rods of equal length are further combined in parallel in a sheath, so that this configuration then comprises a total of about 148,000 light conducting rods.

In a subsequent drawing process, a comparatively large draw ratio can be used, such as 1:2, to obtain a high-resolution multi-fiber rod having a resolution in a range of less than 100 μm.

Instead of a drawing process, a process can be employed at this point in which the aggregate bundle is subjected to heat and vacuum, or to heat and pressure.

In the case of an aggregate bundle of fiber rods with an outer diameter of 35 mm, a high-resolution optical device may be produced in this way, which comprises approximately 148,000 light conducting rods and which has an outer diameter of about 20 mm. The packing density of this device is in a range of more than 99%, and the resolution is about 60 μm.

1-20. (canceled)

21. An optical device for transmitting electromagnetic waves in a wavelength range from 200 nm to 2 μm, comprising:
a plurality of light conducting rods having hexagonal outer contours formed into a bundle, the plurality of light conducting rods having a packing density of at least 90% and a resolution of less than 1 mm.

22. The optical device as claimed in claim 21, wherein the plurality of light conducting rods have a packing density of at least 95%.

23. The optical device as claimed in claim 21, wherein the plurality of light conducting rods have a resolution of less than 100 μm.

24. The optical device as claimed in claim 21, wherein the bundle is enclosed in a tubular sheath.

25. The optical device as claimed in claim 21, wherein the bundle is formed as a light-transmissive cover configured to protect optical sensors.

26. The optical device as claimed in claim 21, wherein the bundle is configured for use as a clock.

27. The optical device as claimed in claim 21, wherein the bundle is configured for use as a device to transfer pictures from a point of origin exposed to high temperature or explosive environments to a point where such exposure is reduced.

28. The optical device as claimed in claim 21, wherein the bundle is configured for use as a portion of a chemical reaction vessel.

29. The optical device as claimed in claim 21, wherein the bundle is configured for use as a portion of a periscope.

30. The optical device as claimed in claim 21, wherein the bundle is configured for use as a portion of a medical endoscope.

31. The optical device as claimed in claim 21, wherein the bundle is configured for use as a high-resolution fiber optic image guide.

32. A method for producing an optical device for transmitting electromagnetic waves in a wavelength range from 200 nm to 2 μm, comprising the steps of:
preparing bundles of parallel light conducting rods of equal length, wherein a cross-sectional area and a number of said light conducting rods is selected in relation to a cross-sectional area of a surrounding sheath;
holding the bundled light conducting rods together; and
subjecting the bundled light conducting rods to a drawing process in which the light conducting rods are fused to one another.

33. The method as claimed in claim 32, wherein the drawing process comprises subjecting the bundled light conducting rods to heat and pressure.

34. The method as claimed in claim 32, wherein the bundled light conducting rods have a packing density of more than 90%.

35. The method as claimed in claim 32, wherein the bundled light conducting rods have a packing density of more than 95%.

36. The method as claimed in claim 32, wherein the bundled light conducting rods have a packing density of more than 98%.

37. The method as claimed in claim 32, further comprising dividing the fused light conducting rods into rod segments or into disk-shaped rod portions.

38. The method as claimed in claim 32, further comprising producing a multi-fiber rod by preparing additional bundles of parallel light conducting rods, holding the bundled light conducting rods together with the fused light conducting rods, subjecting the bundled light conducting rods and fused light conducting rods to another drawing process.

39. The method as claimed in claim 32, wherein the drawing process is performed in vacuum or in an inert gas atmosphere.

40. The method as claimed in claim 32, wherein the optical device is suitable for use as a high-resolution fiber optic image guide.
